(19) United States
(12) Patent Application Publication
(10) Pub. No.: US 2005/0179392 A1
(43) Pub. Date: Aug. 18, 2005

(54) Low-pressure mercury vapor discharge lamp

(75) Inventors: Lars Rene Christian Waumans, Eindhoven (NL); Petrus Johannes Matthijs Van Der Burgt, Eindhoven (NL); Johannes Wilhelmus Anna Maria Gielen, Eindhoven (NL); Adrianus Johannes Hendricus Petrus Van Der Pol, Roosendaal (NL); Johannes Trudo Cornelis Van Kemenade, Eindhoven (NL); Holger Moench, Vaals (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/516,645

(22) PCT Filed: Jun. 5, 2003
(86) PCT No.: PCT/IB03/02367

(30) Foreign Application Priority Data
Jun. 6, 2002 (EP) 02077211.7
Oct. 4, 2002 (EP) 02079125.7

(51) Int. Cl. H01J 17/20; H01J 61/12; H01J 61/18; H01J 61/20

(52) U.S. Cl. 313/639; 313/637; 313/638

(57) ABSTRACT

Low-pressure mercury vapor discharge lamp has a discharge vessel (1) enclosing a discharge space (3) provided with an inert gas mixture and mercury. A first portion (11) of the discharge vessel is provided with a first electrode (12) and a luminescent layer (16), radiating light in a first range of the electromagnetic spectrum. A second portion (21) of the discharge vessel is provided with a second electrode (22), radiating light in a second range of the electromagnetic spectrum, said second range being different from the first range. According to the invention, the low-pressure mercury vapor discharge lamp comprises current supply conductors (12A, 12B; 22A, 22B) for receiving a DC current, and the discharge space contains only two electrodes (12, 22). The discharge lamp has a variable color temperature. Preferably, the discharge lamp influences the melatonin cycle in a human subject. Preferably, the lumen output level is independent of temperature.

The invention relates to a low-pressure mercury vapor discharge lamp comprising a light-transmitting discharge vessel,
the discharge vessel enclosing, in a gastight manner, a discharge space provided with an inert gas mixture and with mercury,
a first portion of the discharge vessel being provided with a first electrode arranged in the discharge space and with a luminescent layer,
which first portion, in operation, radiates light in a first range of the electromagnetic spectrum from 100 to 1000 nm,
a second portion of the discharge vessel being provided with a second electrode arranged in the discharge space,
which second portion, in operation, radiates light in a second range of the electromagnetic spectrum from 100 to 1000 nm, said second range being different from the first range.

The invention also relates to a compact fluorescent lamp.

In mercury vapor discharge lamps, mercury constitutes the primary component for the (efficient) generation of ultraviolet (UV) light. A luminescent layer comprising a luminescent material (for example, a fluorescent powder) may be present on an inner wall of (a portion of) the discharge vessel to convert UV to other wavelengths, for example, to UV-B and UV-A for tanning purposes (sun panel lamps) or to visible radiation for general illumination purposes. Such discharge lamps are therefore also referred to as fluorescent lamps. The discharge vessel of low-pressure mercury vapor discharge lamps is usually circular and comprises both elongate and compact embodiments. Generally, the tubular discharge vessel of compact fluorescent lamps comprises a collection of relatively short straight parts having a relatively small diameter, which straight parts are connected together by means of bridge parts or bent parts. Compact fluorescent lamps are usually provided with an (integrated) lamp cap.

In the description and claims of the current invention, the designation “nominal operation” is used to refer to operating conditions where the mercury-vapor pressure is such that the radiation output of the lamp is at least 80% of that during maximum light output at nominal operation, i.e. under operating conditions where the mercury-vapor pressure is optimal. In addition, in the description and claims, the “initial radiation output” is defined as the radiation output of the discharge lamp 1 second after switching on the discharge lamp, and the “run-up time” is defined as the time needed by the discharge lamp to reach a radiation output of 80% of that during optimum operation.

Low-pressure mercury-vapor discharge lamps are known that comprise an amalgam. Such discharge lamps have a comparatively low mercury-vapor pressure at room temperature. As a result, amalgam-containing discharge lamps have the disadvantage that also the initial radiation output is comparatively low when a customary power supply is used to operate said lamp. In addition, the run-up time is comparatively long because the mercury-vapor pressure increases only slowly after switching-on of the discharge lamp.

Apart from amalgam-containing discharge lamps, low-pressure mercury-vapor discharge lamps are known which comprise both a (main) amalgam and a so-called auxiliary amalgam. If the auxiliary amalgam comprises sufficient mercury, the lamp has a relatively short run-up time. Immediately after the discharge lamp has been switched on, i.e. during pre-heating of the electrodes, the auxiliary amalgam is heated by the electrode so that it dispenses relatively rapidly a substantial part of the mercury that it contains. In this respect, it is desirable that, prior to being switched on, the lamp has been idle for a sufficiently long time to allow the auxiliary amalgam to take up sufficient mercury. If the lamp has been idle for a comparatively short period of time, the reduction of the run-up time is only small. In addition, in that case the initial radiation output is (even) lower than that of a lamp comprising only a main amalgam, which can be attributed to the fact that a comparatively low mercury-vapor pressure is adjusted in the discharge space by the auxiliary amalgam. An additional problem encountered with comparatively long lamps is that it takes comparatively much time for the mercury liberated by the auxiliary amalgam to spread throughout the discharge vessel, so that after switching on such lamps, they exhibit a comparatively bright zone near the auxiliary amalgam and a comparatively dark zone at a greater distance from the auxiliary amalgam, which zones disappear after a few minutes. An alternative version of the low-pressure mercury vapor discharge lamp is the so-called “cold-spot” mercury discharge lamp wherein the mercury pressure is controlled by a so-called cold-spot temperature located somewhere in the discharge vessel.

In addition, low-pressure mercury-vapor discharge lamps are known which are not provided with an amalgam and contain only free mercury. These lamps, also referred to as mercury discharge lamps, have the advantage that the mercury-vapor pressure at room temperature and hence the initial radiation output are relatively high as compared to amalgam-containing discharge lamps and as compared to discharge lamps comprising a (main) amalgam and an auxiliary amalgam. In addition, the run-up time is comparatively short. After having been switched on, comparatively long lamps of this type also show a substantially constant brightness over substantially the whole length, which can be attributed to the fact that the vapor pressure (at room temperature) is sufficiently high at the time of switching-on of these discharge lamps.

A relatively large amount of mercury is necessary for the low-pressure mercury vapor discharge lamps known in the art in order to realize a sufficiently long lifetime. A drawback of these discharge lamps is that they form a burden on the environment. This is in particular the case if the discharge lamps are injudiciously processed after the end of the lifetime. In addition, the lumen output of the low-pressure mercury vapor discharge lamp depends on the temperature.

In the last decade knowledge of human photobiology has increased enormously and has made clear that light radiation that is administered to the human subject or body through the eye—in addition to vision—is of major importance in controlling a variety of biological rhythms. Consequently light radiation has influence not only on many physical body functions but also on mental performance and mood. Findings show a sensitivity of melatonin suppression for light radiation administered through the eye, the melatonin suppression being dependent on dose and spectral composition of the light radiation. Melatonin is a hormone which shows a daily cycle and is considered as a marker of the phase of the biological rhythms. A relatively low melatonin level stimulates alertness; a relatively high melatonin level increases sleepiness. Suppressing melatonin is in the natural daily cycle possible in the “dark” hours. During daytime the level is relatively low, the level increases in the evening, and reaches a maximum at night and decreases gradually to the level during daytime, in the wake-up period. In a 24-hour society many people have to work and drive at night and be alert to perform well and safe, and to sleep well at non-normal hours. Under these conditions many people run an enhanced risk on making mistakes, for example causing car accidents, and/or are likely to suffer from a distorted sleeping behavior.

A low-pressure mercury vapor discharge lamp of the type described in the opening paragraph is known from EP-A 0 658 921. The known low-pressure mercury vapor discharge lamp comprises two interconnected lamp vessels, a first portion provided with a first electrode and with a first luminescent layer and a second portion provided with a second electrode and with a second luminescent layer. Applying a third electrode and supplying high-frequency currents of changing polarity makes the color point adjustable. In the known discharge lamp, the high-frequency current flows through the first portion of the discharge lamp during a first time interval via the first electrode and the third electrode and through the second portion of the discharge lamp during a second time interval via the second electrode and the third electrode. The color point of the light radiated by the known discharge lamp is made adjustable through adjustment of the ratio of the first time interval to the second time interval. A drawback of the use of the known low-pressure mercury vapor discharge lamp is that an additional electrode, high-frequency currents as well as advanced switching and control means are required to provide an adjustable color point.

It is an object of the invention to eliminate the above disadvantage wholly or partly. In particular, it is an object of the invention to provide a low-pressure mercury vapor discharge lamp emitting light in variable ranges of the electromagnetic spectrum whose construction is relatively simple. According to the measure of the invention, a low-pressure mercury vapor discharge lamp of the kind mentioned in the opening paragraph is for this purpose characterized in that the low-pressure mercury vapor discharge lamp comprises current supply conductors for receiving a direct current (DC), the discharge space comprising only two electrodes.

A discharge vessel of a low-pressure mercury vapor discharge lamp according the invention with two electrodes and operating under DC conditions has a gradient in mercury density over the length of the discharge space. Due to this gradient in mercury density, e.g. the first portion of the discharge vessel contains more mercury (ions) than the second portion. The light output of the first portion of the discharge vessel is enhanced and the light output of the second portion is relatively low. In this situation, the light emitted by the low-pressure mercury vapor discharge lamp according to the invention largely corresponds to the electromagnetic spectrum emitted by the first portion. If the polarity of the direct current is reversed, the other electrode becomes the cathode and the gradient in mercury density (gradually) reverses, thereby enhancing the light output of the second portion of the discharge vessel to the detriment of the light output of the first portion, which is lowered. In this situation, the light emitted by the low-pressure mercury vapor discharge lamp according to the invention largely corresponds to the electromagnetic spectrum emitted by the second portion. Regulating the level and/or the polarity of the direct current in the discharge vessel makes it possible for the light emitted by the low-pressure mercury vapor discharge lamp according to the invention to be a mix of the electromagnetic spectrum emitted by the first portion and the second portion of the discharge vessel. In this manner, a low-pressure mercury vapor discharge lamp with an adjustable light emission spectrum is realized comprising only two electrodes.

In the description and claims of the current invention, the designation “light radiated in a range of the electromagnetic spectrum from 100 to 1000 nm” is used to refer to light emitted in the UV-C, UV-B, UV-A and/or in the visible range. By way of example, the first portion of the discharge vessel, in operation, radiates visible light of a first color temperature (by using e.g. a first mix of luminescent materials) and the second portion radiates light of a second color temperature (by using e.g. a second mix of luminescent materials). In another example, the first portion of the discharge vessel, in operation, radiates visible light and the second portion radiates UV-C, UV-B and/or UV-A. In yet another example, the first portion of the discharge vessel, in operation, radiates UV-A and the second portion radiates UV-B. In addition, the first portion of the discharge vessel, when in operation, generates a spectral characteristic stimulating melatonin built-up and the second portion of the discharge vessel, when in operation, generates a spectral characteristic suppressing the melatonin built-up or stimulating melatonin degradation. The person skilled in the art can conceive additional variations within the scope of the invention.

A preferred embodiment of the low-pressure mercury vapor discharge lamp according to the invention is characterized in that an amalgam is provided in the discharge vessel. The (temperature of the) amalgam sets the level of the mercury pressure in the discharge vessel. Decreasing the direct current decreases the power in the discharge vessel, thereby lowering the temperature of the amalgam and thus also lowering the mercury density. A lower mercury density decreases the light output of the portion of the discharge vessel emitting in the first range of the electromagnetic spectrum in favor of the light output of the other portion emitting in the second range of the electromagnetic spectrum. If both portions of the discharge vessel are provided with different mixes of luminescent materials, the average color temperature of the discharge vessel may shift to lower temperatures as a consequence of the decreasing direct current.

The color temperature of the known low-pressure mercury vapor discharge lamps shifts to higher temperatures upon lowering of the electrical power through the discharge vessel. This is, generally speaking, an undesirable property of a low-pressure mercury vapor discharge lamp. For incandescent lamps the color temperature lowers upon dimming the lamp. According to the measure of the invention, the color temperature of low-pressure mercury vapor discharge lamp also shifts to lower temperatures upon dimming of the discharge lamp. This is a favorable property of low-pressure mercury vapor discharge lamps comprising an amalgam according to this embodiment of the invention.

Preferably, the amalgam is provided in a region between the first and the second portion of the discharge vessel. This has the advantage that both portions of the discharge vessel profit approximately equally from the presence of the amalgam, independently of the polarity of the DC current. Due to this “intermediate” position of the amalgam, the mercury pressure above the amalgam is practically constant and independent of the DC polarity, resulting in a minimal time period for the change in spectral emission between the first portion and the second portion.

A preferred embodiment of the low-pressure mercury vapor discharge lamp according to the invention is characterized in that the amalgam is provided in the region of the electrode of the portion of the discharge vessel with the lowest color temperature. In another preferred embodiment of the low-pressure mercury vapor discharge lamp according to the invention the amalgam is provided in the region of the first electrode and a further amalgam is provided in the region of the second electrode. This embodiment has the advantage that irrespective of the polarity of the DC current an amalgam is available in the vicinity of the first or second electrode. Depending on the polarity of the DC current, the mercury (ions) migrate(s) towards the electrode which functions as the cathode. Whether the first or the second electrode acts as the cathode, an amalgam for regulating the mercury pressure is available in the vicinity of the cathode, thereby ensuring a more reliable operation of the low-pressure mercury vapor discharge lamp.

A preferred embodiment of the low-pressure mercury vapor discharge lamp according to the invention is characterized in that a cold spot is provided in the discharge vessel. Preferably, the cold spot is provided in the region between the first and second portion of the discharge vessel. If, in addition, an amalgam is provided in the low-pressure mercury vapor discharge lamp, the amalgam is, preferably, provided in the region of the cold spot. In the latter embodiment the amalgam is relatively easily provided in the vicinity of the middle of the discharge lamp. In addition, in highly-loaded applications, the cold spot has a lower temperature then in the known low-pressure mercury vapor discharge lamp in which the amalgam is provided in the lamp cap. In this manner “normal” amalgams can be employed in low-pressure mercury vapor discharge lamps which are highly loaded.

A preferred embodiment of the low-pressure mercury vapor discharge lamp according to the invention is characterized in that a wall of the second portion of the discharge vessel is made from a glass which is transmissible to UV. UV-transmissive glass is used e.g. for purposes of disinfection in e.g. hospitals or clinical laboratories. The principle of adjusting the electromagnetic spectrum of the discharge vessel as described above can be employed by switching the discharge lamp from one function (e.g. general lighting during daytime) to the other function (e.g. disinfection during nighttime). A great advantage here is that two functions for which at the moment two discharge lamps, including two ballasts and fixtures are required, are combined in a single lamp including one ballast and one fixture. This is particularly advantageous in situations where there is limited space available and/or additional weight has to be avoided. For example in airplanes such a low-pressure mercury vapor discharge lamp according to the invention can be successfully employed: when the passengers are in the plane, the discharge lamp is used for general lighting purposes and when the passengers are absent the discharge lamp is switched to emit UV light (e.g. for cleansing purposes).

An alternatively preferred embodiment of the low-pressure mercury vapor discharge lamp according to the invention is characterized in that the second portion of the discharge vessel is provided with a further luminescent layer. In operation, the further luminescent layer in the second portion emits light of a color temperature that is different from the light emitted by the luminescent layer in the first portion of the discharge lamp. By properly selecting the color temperature of the light emitted by the first and second portion, an entire range of color temperatures is encompassed by the low-pressure mercury vapor discharge lamp according to the invention. It is noted that the luminescent layer and the further luminescent layer may overlap each other partly at a transition between the first and second portion.

According to a preferred embodiment of the low-pressure mercury vapor discharge lamp according to the invention, the luminescent layer of the first portion comprises a luminescent material emitting UV-A radiation, and the further luminescent layer of the second portion comprises a luminescent material emitting UV-B radiation or emitting UV-A and UV-B radiation. Normal operation of a low-pressure mercury vapor discharge lamp according to this embodiment of the invention leads to a discharge lamp with a balanced UV distribution over the length of the discharge lamp. By operating the lamp on a DC current, the ratio of UV-A and UV-B can be tuned. In particular, when the first electrode is made cathode, mercury tends to migrate to the first portion of the discharge lamp, the discharge lamp mainly emitting UV-A radiation. In addition, when the second electrode is made cathode, mercury tends to migrate to the second portion of the discharge lamp, the discharge lamp mainly emitting UV-B radiation or a mix of UV-A and UV-B radiation. By combining an AC and a DC current, the ratio of TV-A and UV-B radiation can be tuned. Preferably, an amalgam is employed to ensure a relatively fast switching.

In order to reduce the risk on making mistakes of people that have to function at non-normal hours, a preferred embodiment of the low-pressure mercury vapor discharge lamp according to the invention is characterized in that, in operation, the luminescent layer yields a spectral characteristic stimulating melatonin built-up in a human subject or yields a spectral characteristic suppressing the melatonin built-up or stimulating melatonin degradation in the human subject. Melatonin, as the marker of the biological rhythms, is generally known as a sleeping hormone that influences the alertness of the human subject. Hence, when the melatonin cycle is controlled, the risk on making mistakes because of lack of alertness is decreased. Peak sensitivity for the melatonin suppression is between 410-430 nm, with decreasing efficacy to approximately zero at 560 nm. Besides, the doses to suppress melatonin as function of the wavelength are known for fully dilated pupils.

Recent findings deviate from earlier statements that the sensitivity of melatonin suppression would be similar to scotopic night-vision sensitivity, as the maximum sensitivity for scotopic vision is at a wavelength λ of approximately 509 mm. It appeared that the melatonin suppression sensitivity, compared with the scotopic night vision sensitivity, is shifted towards a shorter wavelength region. In particular, short wavelengths have a substantial effect on the melatonin suppression although the vast majority of recognized light receptors in the retina have activation wavelengths λ of 500 nm or greater. Below 500 nm, the only recognized receptors in the human eye are the blue cones, which have a λₘₐₓ of 420 nm, and these are present in amounts corresponding to less than 1% of any other family of light receptors in the retina. It is advantageous that light of such short wavelengths is able to suppress melatonin production as considerably less light is required, owing to its increased efficacy. In addition, the amount of light that is necessary to effect melatonin suppression can be substantially reduced if the optimal wavelength, or band of wavelengths, is selected, thereby avoiding any problems with sight caused by undue glare or intense illumination.

Melatonin is produced by the pineal gland and it is believed that appropriate afferent optical nerves have an effect on the production of melatonin by the pineal gland. In particular, it is demonstrated that subjects directly observing a source of short wavelength light experience an acute reduction in the production of melatonin. However, there are also indications that administration of light to non-ocular parts of the body can affect the melatonin suppression of the subject. Accordingly, it is preferred that the light of the present invention is administered via the ocular, but it will be appreciated that administration to other parts of the body is also envisaged. Besides, the doses to suppress melatonin as function of the wavelength are known for fully dilated pupils.

Experiments have shown that the greatest sensitivity to short wavelength light is in the region just above the ultraviolet. Ultraviolet is generally accepted as being light radiation below approximately 380 nm. In particular, there is particularly high sensitivity to light in the region of 420-460 nm, and this sensitivity tails off with higher wavelengths, with decreasing efficacy to approximately zero at 560 nm. As noted above, the wavelength of the light is greater than ultraviolet, although the present invention envisages wavelengths in the broader region with ultraviolet. In general, though, ultraviolet light should be avoided, in order to minimize risk to the subject.

A preferred embodiment of the low-pressure mercury vapor discharge lamp according to the invention is characterized in that, in operation, the farther luminescent layer yields a spectral characteristic suppressing the melatonin built-up in a human subject or stimulating melatonin degradation or yields a spectral characteristic stimulating melatonin built-up in the human subject. Preferably, the luminescent layer and the further luminescent layer have opposite functions with respect to the melatonin cycle. To this end, a particularly preferred embodiment of the low-pressure mercury vapor discharge lamp according to the invention is characterized in that the luminescent layer yields a spectral characteristic stimulating melatonin built-up and the further luminescent layer yields a spectral characteristic suppressing the melatonin built-up or stimulating melatonin degradation. As according to the invention the light output of the low-pressure mercury vapor discharge lamp can be changed from the first portion of the discharge vessel to the second portion of the discharge vessel and vice versa, the same discharge lamp can on the one hand be used to suppress the melatonin built-up or to stimulate melatonin degradation and on the other hand to stimulate formation of melatonin in the human subject.

A further preferred embodiment of the low-pressure mercury vapor discharge lamp according to the invention is characterized in that the spectral characteristic is specified by an output fraction of melatonin suppressive radiation Rₛᵣ and light output Lₒ, the melatonin suppressive radiation being Rₛᵣ≧0.45 Melatonin Watt/Watt and the light output being Lₒ≦60 lumen/Watt. In this embodiment the melatonin is suppressed efficiently but with relatively low output of visible light radiation. These embodiments are particularly suitable for nursing activities. However, as the eye sensitivity for light is dependent on the age of the human, an embodiment is preferred in which the method is characterized in that the output fraction of melatonin suppressive radiation is Rₛᵣ≧0.45 Melatonin Watt/Watt and that the light output is Lₒ≦20 lumen/Watt. This embodiment is particularly appropriate to be used for relatively young people who have a high sensitivity for light, the melatonin is suppressed efficiently and the output of the visible light radiation is very low. As the melatonin suppression is obtainable by light radiation that yield only a very low amount of visual light/lumen, i.e. deep blue, the melatonin suppressive radiation hardly influences the visual conditions created by light for vision purposes. These embodiments find application in activities in which a dim visible lighting level is needed but in which activities require that people has to be kept alert and awake, for example in a control room of e.g. an air field. Yet, even more demands are posed upon lighting levels for truck drivers at night, these drivers have to be both kept alert during their ride and must have good sight on the road. Therefore in a preferred embodiment, the output fraction of melatonin suppressive radiation is Rₛᵣ≧0.45 Melatonin Watt/Watt and that the light output is Lₒ≦10 lumen/Watt. The low light output of Lₒ≦10 lumen/Watt facilitates to relatively easily obtain a lighting level inside the cabin of the truck that is sufficiently low not to form a disturbance for the truck driver. Under these conditions, a truck drive, by way of example, is enabled both to stay awake and to have a good view on the road.

In circumstances that people have to be kept alert and vision conditions are determined only by a relatively simple task, melatonin suppressive radiation together with a sufficiently amount of visible light can be administered. Examples of such circumstances are outdoor container work activities in a shipyard, which work only requires that articles can be distinguished by their shape and/or text. For these circumstances an embodiment of the method is characterized in that the output fraction of melatonin suppressive radiation is Rₛᵣ≧0.45 Melatonin Watt/Watt and the light output is Lₒ≧60 lumen/Watt.

In circumstances that people have to be kept alert and good color vision conditions are required to carry out the task, melatonin suppressive radiation together with relatively high amounts of visible light can be administered. Examples of such circumstances are shift work, first aid centers in hospitals, etc. For these circumstances an embodiment of the method is characterized in that the output fraction of melatonin suppressive radiation is Rₛᵣ≧0.45 Melatonin Watt/Watt and the light output is Lₒ≧100 lumen/Watt, the light source preferably having a color rendering index Rₐ≧65. Other examples for melatonin suppressive lighting methods are in schools, universities, libraries in classrooms, lecture halls, conference rooms. Preferably an embodiment the method is characterized in that the output fraction of melatonin suppressive radiation is Rₛᵣ≧0.6 Melatonin Watt/Watt and the light output is Lₒ≧100 lumen/Watt, the light source preferably having a color rendering index Rₐ≧65 and a color temperature of T_{c}≧6500 K. This method is appropriate for people not having options to catch sufficient daylight for example in the winter period, or elderly people with disturbed rhythms, or people with Monday morning hangover. The color temperature is relatively high which has a supporting psychological effect on the alertness next to the effect on alertness by melatonin suppression. Light having the properties of Rₛᵣ≧0.45 Melatonin Watt/Watt and Lₒ≧100 lumen/Watt is obtainable by a single light source but alternatively is obtainable by combinations of light sources. A first portion of the discharge vessel emits light with a relatively high lumen output, for example a first portion with a so-called/80 luminescent layer with Lₒ≧200 lumen/Watt and a color rendering index Rₐ≧80, whereas a second portion of the discharge vessel emits light having a relatively high melatonin suppressive radiation output, for example a second portion with a so-called/03 luminescent layer with Rₛᵣ≧0.7 Melatonin Watt/Watt. The lighting system obtained in this manner has a light source yielding the suitable light radiation and has the advantage that it is relatively cheap.

In the case visual conditions are demanding, for example work for some hours in the evening, and sleep quality should not be decreased and thus to reduce the risk on making mistakes the day after, light should be provided that influences the melatonin cycle to a relatively small degree. For these applications the low-pressure mercury vapor discharge lamp of the invention is characterized in that the output fraction of melatonin suppressive radiation is Rₛᵣ≦0.2 Melatonin Watt/Watt and the light output is Lₒ≧100 lumen/Watt, the light source having a color rendering index Rₐ≧65, preferably the output fraction of melatonin suppressive radiation is Rₛᵣ≦0.1 Melatonin Watt/Watt. Such applications can be found for people who wake up shortly in night hours or need to be inspected during night hours for example at home for elderly but also for parents with young kids, elderly homes, hospitals, nursing homes. In these cases the melatonin non-suppressive light for the ‘sleepers’ can be combined with alerting light for the “watchers” in their working/observation room. Such types of light can be special nightlights, optionally integrated in bed head-units, orientation lights in halls, doorways, and stairs.

In an embodiment, the low-pressure mercury vapor discharge lamp is characterized in that the output fraction of melatonin suppressive radiation shifts from Rₛᵣ≧0.45 Melatonin Watt/Watt to Rₛᵣ≦0.2 Melatonin Watt/Watt or vice versa and the light output is Lₒ≧100 lumen/Watt, the light source having a color rendering index Rₐ≧65. In this manner a controlled gradual change from melatonin suppressive radiation to non-suppressive radiation is obtainable whereby also continuously sufficient light is provided, enabling people to work correctly. The latter embodiment is usable for example in light for people working in fast rotating shifts, eventually starting with a short period with suppressive light and ending with a period with non-suppressive light to accommodate easy sleep onset after the night shift and prevent any phase shifting of the biological clock. The method involving a shift from melatonin non-suppressive to suppressive radiation, depending on time of day, is usable in applications to re-synchronize biological clock in the case of traveling over various time zones, i.e. jet-lag.

Lighting systems having a light output of Lₒ≧100 lumen/Watt, a color rendering index Rₐ≧65 and the possibility to shift from melatonin suppressive radiation output of Rₛᵣ≧0.45 Melatonin Watt/Watt to Rₛᵣ≦0.2 Melatonin Watt/Watt, may contain a single light source but alternatively may contain first portion and a second portion of the same light source and also a combination of a first and second light source. In the embodiment of the lighting system containing a single light source, the output of the single light source is adjustable, for example by changing the gradient in mercury density.

In another preferred embodiment of the low-pressure mercury vapor discharge lamp according to the invention the low-pressure mercury vapor discharge lamp is adapted to receive an alternating current. Lamp operation on an alternating current gives both the first and the second portion of the discharge lamp the optimal mercury density so as to emit approximately the same amount of light in both ranges of the electromagnetic spectrum, and an average color temperature is preferably achieved. By adjusting the level and/or the polarity of the DC current light emission by the first portion can be given preference over that of the second portion of the discharge vessel. Combining DC and AC operational conditions for the discharge lamp gives a full range of possibilities for adjusting the emission spectrum of the low-pressure mercury vapor discharge lamp according to the invention.

In order to reduce the amount of mercury is necessary for the low-pressure mercury vapor discharge lamps, a preferred embodiment of the low-pressure mercury vapor discharge lamp according to the invention is characterized in that the discharge lamp comprises an at least partly substantially cylindrical discharge vessel with a length L_{dv} and with an internal diameter Dᵢₙ, and the ratio of the weight of mercury m_{Hg} in the discharge vessel and the product of the internal diameter Dᵢₙ and the length of the discharge vessel L_{dv} is given by the relation:

$$\frac{{m}_{Hg}}{{D}_{in} \times {L}_{dv}} = C ,$$

wherein C≦0.01 μg/mm². A discharge vessel of a low-pressure mercury vapor discharge lamp according the this embodiment of the invention having a ratio of the weight (expressed in μg) of mercury and the product of the internal diameter (expressed in mm) and the length (expressed in mm) of the discharge vessel which is below 0.01 μg/mm², contains a relatively low amount of mercury. The mercury content is considerably lower than what is normally provided for in known low-pressure mercury vapor discharge lamps. Giving the range of the constant C≦0.01 μg/mm², the low-pressure mercury vapor discharge lamp according to this embodiment of the invention operates for certain ambient temperatures as a so-called “unsaturated” mercury vapor discharge lamp.

The above given formula shows that the amount of mercury in the discharge lamp is proportional to the product of the internal diameter Dᵢₙ and the length of the discharge vessel L_{dv}. Roughly speaking, the amount of mercury in the discharge lamp is proportional to the size of the internal surface of the discharge vessel. Experiments have shown that the formula can at least be applied for low-pressure mercury vapor discharge lamps with a diameter of the discharge vessel in the range from approximately 3.2 mm (⅛ inch) to approximately 38 mm ( 12/8 inch) and for (corresponding) lengths in the range from approximately 10 mm (⅓ foot) and approximately 27·10² mm (9 foot) of the discharge vessel.

In the description and claims of the present invention, the designations “unsaturated” or “unsaturated mercury conditions” are used to refer to a low-pressure mercury vapor discharge lamp in which the amount of mercury dosed into the discharge vessel (during manufacturing) of the low-pressure mercury vapor discharge lamp is equal to or lower than the amount of mercury needed for a saturated mercury vapor pressure at nominal operation of the discharge lamp.

Operating a mercury vapor discharge lamp under unsaturated mercury conditions has a number of advantages. Generally speaking, the performance of unsaturated mercury discharge lamps (light output, efficacy, power consumption, etc.) is independent of the ambient temperature as long as the mercury pressure is unsaturated. This results in a constant light output which is independent on the way of burning the discharge lamp (base up versus base down, horizontally versus vertically, etc.). In practice, a higher light output of the unsaturated mercury vapor discharge lamp is obtained in the application. Unsaturated lamps combine a higher light output and an improved efficacy in applications at elevated temperatures with minimum mercury content. This results in ease of installation and in freedom of design for lighting and luminaire designers. An unsaturated mercury discharge lamp gives a relatively high system efficacy in combination with a relatively low Hg content. In addition, unsaturated lamps have an improved maintenance. Because the trends towards further miniaturization and towards more light output from one luminaire will continue the forthcoming years, it may be anticipated that problems with temperature in application will more frequently occur in the future. With an unsaturated mercury vapor discharge lamp these problems are largely reduced. Unsaturated lamps combine minimum mercury content with an improved lumen per Watt performance at elevated temperatures. This embodiment of the invention enables the manufacturing of long-life low-pressure mercury vapor discharge lamps which operate under conditions of unsaturated mercury content. Such unsaturated mercury discharge lamps have the additional advantage that the burden on the environment is reduced.

Preferably, the constant C is in the range 0.0005≦C≦0.005 μg/mm². In this regime of C the upper limit of the mercury content in the discharge lamp is further reduced. In this preferred embodiment of the invention, the low-pressure mercury vapor discharge lamp according to the invention operates as an unsaturated mercury vapor discharge lamp.

Instead of expressing the mercury content in the discharge vessel in terms of the amount of mercury present in the discharge vessel, the mercury content can also be expressed as the pressure of mercury in the discharge vessel of the low-pressure mercury vapor discharge lamp. According to another embodiment of the invention, a low-pressure mercury vapor discharge lamp for this purpose characterized in that the discharge lamp comprises an at least partly substantially cylindrical discharge vessel with a length L_{dv} and with an internal diameter Dᵢₙ, and the product of the mercury pressure p_{Hg} and the internal diameter Dᵢₙ of the discharge vessel is in the range 0.13≦p_{Hg}×Dᵢₙ≦8 Pa.cm. A discharge vessel of a low-pressure mercury vapor discharge lamp according to this embodiment of the invention in which the product of the mercury pressure (expressed in Pa) and the internal diameter (expressed in mm) of the discharge vessel which is in the mentioned range from, contains a relatively low amount of mercury. The mercury content is considerably lower than what is normally provided for in known low-pressure mercury vapor discharge lamps. The low-pressure mercury vapor discharge lamp according to the second measure of the invention operates as a so-called ”unsaturated” mercury vapor discharge lamp.

Preferably, the product of the mercury pressure p_{Hg} and the internal diameter Dᵢₙ of the discharge vessel is in the range 0.13≦p_{Hg}×Dᵢₙ≦4 Pa.cm. In this preferred regime of p_{Hg}×Dᵢₙ the mercury content in the discharge lamp is further reduced. In this preferred embodiment of the invention, the low-pressure mercury vapor discharge lamp according to the invention operates as an unsaturated mercury vapor discharge lamp.

Another preferred embodiment of the low-pressure mercury vapor discharge lamp according to the invention is characterized in that the discharge vessel contains less than approximately 0.2 mg mercury. There is a tendency in governmental regulations to prescribe a maximum amount of mercury present in a low-pressure mercury vapor discharge lamp that if the discharge lamp comprises less than said prescribed amount allows the user to dispose of the lamp without environmental restrictions. If a mercury discharge lamp contains less than 0.2 mg of mercury such requirements are largely fulfilled. Preferably, the discharge vessel contains less than or equal to approximately 0.05 mg mercury (C≈0.0013).

It is not an easy task to operate a low-pressure mercury vapor discharge lamp under unsaturated mercury conditions according to the above described embodiment of the invention while simultaneously realizing a relatively long life of the discharge lamp. It is known that measures are taken in low-pressure mercury vapor discharge lamps to reduce the amount of mercury that during life of the discharge lamp is no longer able to contribute to the reactive atmosphere in the discharge space in the discharge vessel. Mercury is lost in that, due to the interaction of mercury and materials present in the lamp (such as glass, coatings, electrodes) and parts of the inner wall of the discharge vessel are blackened. Wall blackening does not only give rise to a lower light output but also gives the lamp an unaesthetic appearance, particularly because the blackening occurs irregularly, for example, in the form of dark stains or dots.

These and other aspects of the invention are apparent from and will be elucidated with reference to the embodiments described hereinafter.

In the drawings:

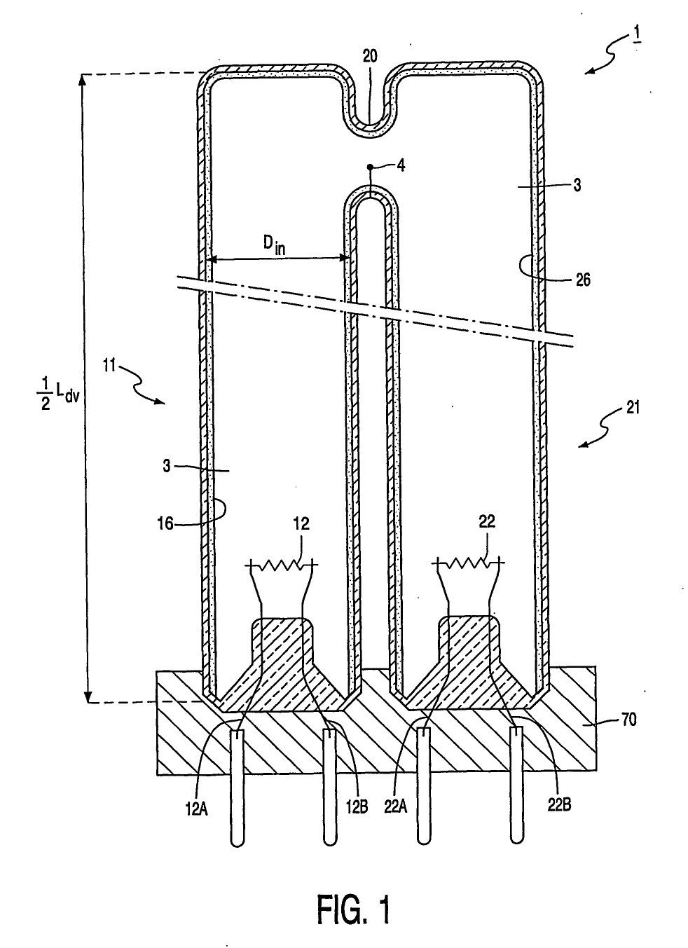

FIG. 1 is a cross-sectional view of an embodiment of a compact fluorescent lamp comprising a low-pressure mercury-vapor discharge lamp in accordance with the invention;

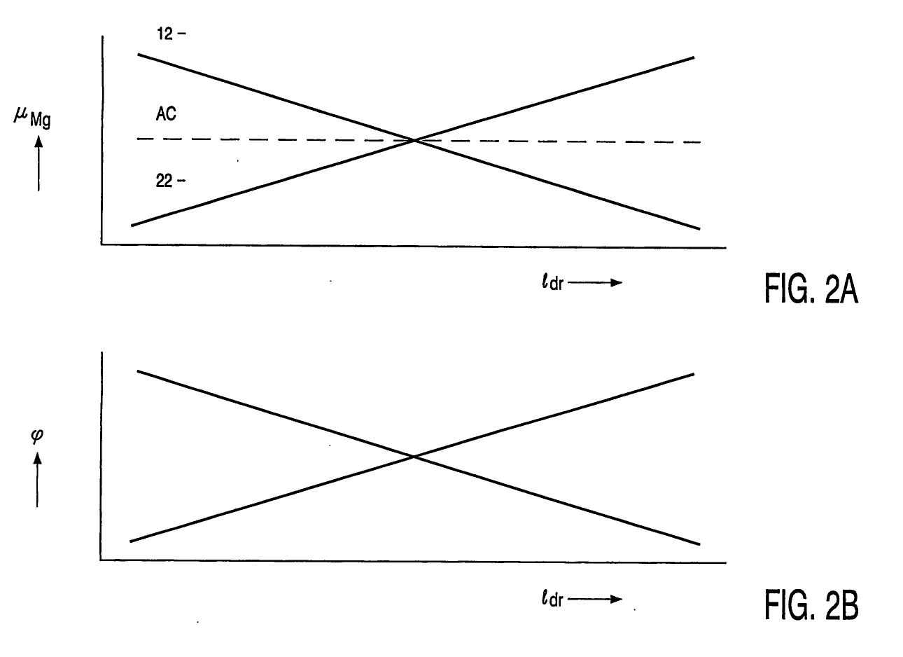

FIG. 2A shows the mercury density as a function of the position in the discharge vessel 1;

FIG. 2B shows schematically the corresponding light output of the discharge vessel as a function of the position in the discharge vessel, and

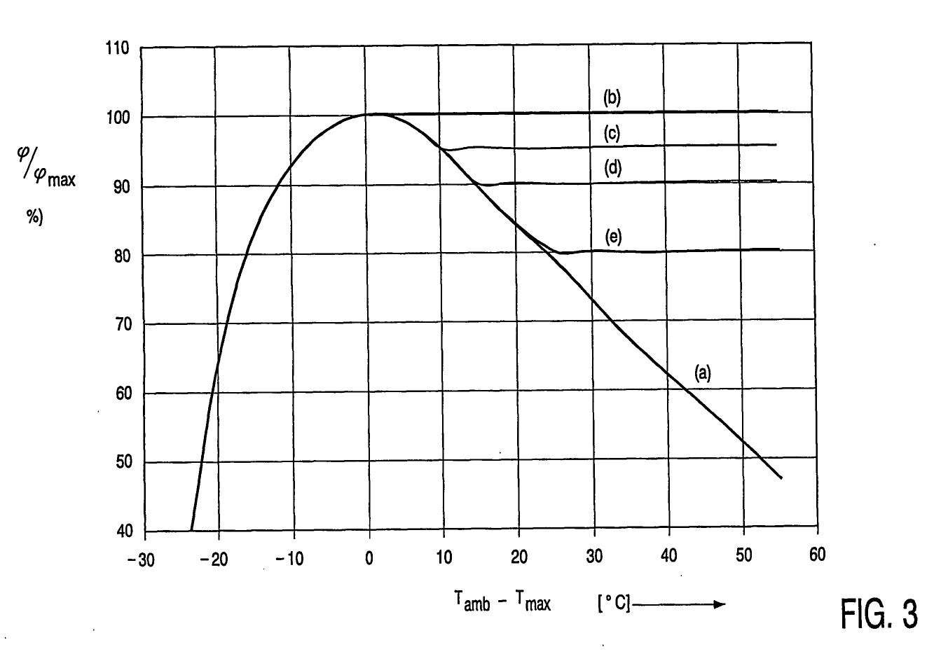

FIG. 3 shows the relative luminous flux of low-pressure mercury vapor discharge lamps as function of the relative ambient temperature.

The Figures are purely diagrammatic and not drawn to scale. Particularly for clarity, some dimensions are exaggerated strongly. Similar components in the Figures are denoted as much as possible by the same reference numerals.

FIG. 1 shows a compact fluorescent lamp comprising a low-pressure mercury-vapor discharge lamp. Said low-pressure mercury-vapor discharge lamp is provided with a radiation-transmitting discharge vessel 1 which encloses a discharge space 3 having a volume of approximately 10 cm³ to 100 cm³ in a gastight manner. The discharge vessel 1 is a glass tube which is at least substantially circular in cross-section and which has a length L_{dv} and an (effective) inner diameter Dᵢₙ. The discharge vessel 1 comprises a first portion 11 and a second portion 21. In the example of FIG. 1 the first and the second portion 11, 21 each have a length ½L_{dv} and are interconnected via a channel or bridge 20. In an alternative embodiment, the discharge vessel is folded and e.g. comprises bent parts. A first portion 11 of the discharge vessel 1 is provided with a first electrode 12 arranged in the discharge space 3. At an inner wall of the first portion 11 of the discharge vessel 1 a luminescent layer 16 is provided. In operation, the first portion 11 radiates light in a first range of the electromagnetic spectrum from 100 to 1000 nm. By way of example the first range may correspond to a first color temperature, the first color temperature being e.g. 2700 K. The second portion 21 of the discharge vessel 1 is provided with a second electrode 22 arranged in the discharge space 3. In the example of FIG. 1, a further luminescent layer 26 is provided at an inner wall of the second portion 21 of the discharge vessel 1. In operation, the second portion 21 radiates light in a second range of the electromagnetic spectrum from 100 to 1000 nm. By way of example the second range may correspond to a second color temperature, the second color temperature being e.g. 6500 K. In an alternative embodiment, the further luminescent layer is omitted. In that case, the wall of the second portion of the discharge vessel, preferably, is made from a glass which is transmissible to UV, said second portion emitting e.g. UV-C.

In a further alternative embodiment the first portion emits UV-A and the second portion emits UV-B or emits UV-A and UV-B. Normal operation of a low-pressure mercury vapor discharge lamp according to this embodiment of the invention leads to a discharge lamp with a balanced UV distribution over the length of the discharge lamp. By operating the lamp on a DC-current, the ratio of UV-A and UV-B can be tuned. In particular, when the first electrode is made cathode, mercury tends to migrate to the first portion of the discharge lamp, and the discharge lamp mainly emits UV-A radiation. In addition, when the second electrode is made cathode, mercury tends to migrate to the second portion of the discharge lamp, and the discharge lamp mainly emits UV-B radiation or a mix of UV-A and UV-B radiation. By combining an AC and a DC current, the ratio of UV-A and UV-B radiation can be tuned. Preferably, an amalgam is employed to ensure a relatively fast switching. Suitable luminescent materials for emitting UV-A radiation for application in a low-pressure mercury vapor discharge lamp according to the invention are BaSi₂O₅:Pb²⁺ (also known as BSP) and SrB₄O₇:Eu²⁺ (also known as SBE). Suitable luminescent materials for emitting UV-B radiation are Ce_{0.45}La_{0.40}Tb_{0.15}PO₄ (also known as LAP-Ce) and SrAl₁₂O₁₉:Ce³⁺ (also known as SAC).

The skilled person easily conceives additional variations of emission spectra emitted by the first and second portion of the discharge vessel of the low-pressure mercury vapor discharge lamp within the scope of the invention.

The electrode pair 12; 22 generally is a winding of tungsten covered with an electron-emitting substance, in this case a mixture of barium oxide, calcium oxide and strontium oxide. Each of the electrodes 12; 22 is supported by a (narrowed) end portion of the discharge vessel 1. Current supply conductors 12A, 12B; 22A, 22B extend from the electrode pair 12; 22 through the end portions of the discharge vessel 1 where they issue to the exterior. The current supply conductors 12A, 12B; 22A, 22B are connected to an (electronic) power supply. For the application of DC currents to the electrodes, in principle, it is sufficient if either the current supply conductors 12A and 22A or the current supply conductors 12B and 22B. If the low-pressure mercury vapor discharge lamp operates under DC operation only, half of the number of current supply conductors can be omitted.

The discharge vessel 10 of the low-pressure mercury-vapor discharge lamp can be surrounded by a light-transmitting envelope (not shown in FIG. 1), which is secured to the lamp housing 70. The light-transmitting envelope generally has a matt appearance.

In the example of FIG. 1, mercury is not only present in the discharge space 3 but also in an amalgam 4 provided in a region between the first and the second portion 11, 21 of the discharge vessel 1. In an alternative embodiment, the amalgam is provided in the region of the electrode of the portion of the discharge vessel with the lowest color temperature. In a further alternative embodiment, the amalgam is provided in the region of the first electrode and a further amalgam is provided in the region of the second electrode. In operation, the amalgam 4 is in communication with the discharge space 3. In an alternative embodiment, the discharge vessel is further provided with a so-called auxiliary amalgam (not shown in FIG. 1).

FIG. 2A schematically shows the mercury density μHg as a function of the position 1_{dv} in the discharge vessel 1. FIG. 2B schematically shows the corresponding light output φ of the discharge vessel 1 as a function of the position 1_{dv} in the discharge vessel. When the discharge lamp is operated on a direct current (with an electronic circuit), the mercury ions will drift towards the cathode side of the lamp. This leads to a gradient in the mercury distribution and accordingly to a gradient in the light output as can be seen in FIGS. 2A and 2B. When electrode 12 is the cathode (indicated by “12-” in FIG. 2A), the light output will have the emission spectrum, e.g. a first color temperature, corresponding to the first portion 12 of the discharge vessel 1. When the second electrode 22 is made cathode (indicated by “22-” in FIG. 2A), the light will have the emission spectrum, e.g. a second color temperature, according to the second portion 22 of the discharge vessel 1. By regulating the DC level of the current, the emission spectrum, e.g. the color temperature, of the discharge lamp is made adjustable. Since the amalgam 4 is positioned in the middle of the discharge vessel, the mercury pressure above the amalgam is constant and independent of the DC polarity. This ensures a minimal time between the changes of color.

By decreasing the level of the DC current, the power in the discharge vessel 1 decreases and therefore the temperature of the amalgam 4 lowers and the total mercury density lowers. This implied that the light output of both the first and the second portion 11; 21 shifts to the left over the light output versus mercury density curve. This results in a lower light output for the portion with the higher color temperature and an increased light output for the portion with the lower color temperature. By dimming, the color temperature shifts to lower temperatures, as is the case in normal incandescent lamps. In an alternative embodiment, a so-called cold spot is used instead of an amalgam.

FIG. 2A also shows the situation in which the low-pressure mercury vapor discharge lamp operates under AC conditions. In this situation, the light from the two portions mix into a color temperature which lies approximately in between the first and the second color temperature.

In order to reduce the risk on making mistakes of people that have to function at non-normal hours, the luminescent layer in the first portion of the discharge vessel, when in operation, generates a spectral characteristic stimulating melatonin built-up and the further luminescent layer in the second portion of the discharge vessel, when in operation, generates a spectral characteristic suppressing the melatonin built-up or stimulating melatonin degradation. The light output of the low-pressure mercury vapor discharge lamp can be changed from the first portion of the discharge vessel to the second portion of the discharge vessel and vice versa, the same discharge lamp can on the one hand be used to suppress the melatonin built-up or to stimulate melatonin degradation and on the other hand to stimulate formation of melatonin in the human subject.

In order to make the performance of unsaturated mercury discharge lamps (light output, efficacy, power consumption, etc.) independent of the ambient temperature, the ratio of the weight of mercury m_{Hg} in the discharge vessel and the product of the internal diameter Dᵢₙ and the length of the discharge vessel L_{dv} is given by the relation:

$$\frac{{m}_{Hg}}{{D}_{in} \times {L}_{dv}} = C ,$$

wherein C≦0.01 μg/mm². Preferably, 0.0005≦C≦0.005 μg/mm². Under these conditions, the low-pressure mercury vapor discharge lamp (depending on the ambient temperature) as a so-called “unsaturated” mercury vapor discharge lamp.

In FIG. 3 the relative luminous flux of low-pressure mercury vapor discharge lamps as a function of the relative ambient temperature is shown for various values of the constant C. The light output or luminous flux φ is expressed as a percentage of the maximum luminous flux φₘₐₓ and the ambient temperature T_{amb} is given relative to the temperature at the maximum luminous flux Tₘₐₓ. Curve (a) in FIG. 3 depicts the situation for a known low-pressure mercury vapor discharge lamp with a relatively high amount of mercury dosed into the discharge vessel during manufacturing of the discharge lamp. It can be observed from curve (a) that the luminous flux φ is dependent on the ambient temperature T_{amb}, i.e. the higher the ambient temperature the lower the light output of the discharge lamp. Such temperature dependent behavior largely limits the possibilities for further miniaturization of low-pressure mercury vapor discharge lamps, in particular of compact fluorescent lamps in which the discharge vessel 10 is surrounded by a light-transmitting envelope 60 (see FIG. 2).

Curve (b) in FIG. 3 depicts the situation for an unsaturated low-pressure mercury vapor discharge lamp according to the invention. In this example C≈0.0013. In the situation of curve (b) in FIG. 3, the discharge lamp is supplied with an amount of mercury which makes the discharge lamp to operate under unsaturated mercury conditions when the ambient temperature is approximately equal to the maximum temperature Tₘₐₓ. It can be seen that the luminous flux is independent of the temperature for ambient temperatures higher than Tₘₐₓ. With a mercury vapor discharge lamp operating under unsaturated mercury conditions the trend in the marketplace towards further miniaturization and towards more light output can be followed.

Curve (c) in FIG. 3 depicts the situation for an unsaturated low-pressure mercury vapor discharge lamp according to the invention. In this example C≈0.0021. In the situation of curve (c) in FIG. 3, the discharge lamp is supplied with such an amount of mercury resulting in 5% less light than under optimal conditions when the lamp becomes unsaturated (corresponding to approximately 21/13 times the optimal Hg dosing). It can be seen that the luminous flux is independent of the temperature for ambient temperatures approximately 10° C. above the maximum temperature.

Curve (d) in FIG. 3 depicts the situation for an unsaturated low-pressure mercury vapor discharge lamp according to the invention. In this example C≈0.0040. In the situation of curve (d) in FIG. 3, the discharge lamp is supplied with such an amount of mercury resulting in 10% less light than under optimal conditions when the lamp becomes unsaturated (corresponding to approximately 40/13 times the optimal Hg dosing). It can be seen that the luminous flux is independent of the temperature for ambient temperatures approximately 15° C. above the maximum temperature.

Curve (e) in FIG. 3 depicts the situation for an unsaturated low-pressure mercury vapor discharge lamp according to the invention. In this example C≈0.008. In the situation of curve (e) in FIG. 3, the discharge lamp is supplied with such an amount of mercury resulting in 20% less light than under optimal conditions when the lamp becomes unsaturated (corresponding to approximately 80/13 times the optimal Hg dosing). It can be seen that the luminous flux is independent of the temperature for ambient temperatures approximately 25° C. above the maximum temperature.

Unsaturated mercury vapor discharge lamps are quick starters and have a fast run-up time. By way of example, the initial radiation output of a typical unsaturated mercury vapor discharge lamp is approximately 38% whereas the initial radiation output for a known discharge lamp provided with an amalgam is approximately 6%. The “run-up time” of the same unsaturated discharge lamp is approximately 75 seconds whereas the run-up time for a known discharge lamp provided with an amalgam is approximately 210 seconds. In addition, unsaturated mercury vapor discharge lamps have a 25% lower ignition voltage as compared to known discharge lamp provided with an amalgam. Unsaturated mercury vapor discharge lamp typically contain less than 0.1 mg mercury. From experiments it was observed that the maintenance of unsaturated mercury vapor discharge lamp is higher than approximately 98% at 10,000 hours.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A low-pressure mercury vapor discharge lamp comprising a light-transmitting discharge vessel,
the discharge vessel enclosing, in a gastight manner, a discharge space provided with an inert gas mixture and with mercury,
a first portion of the discharge vessel being provided with a first electrode arranged in the discharge space and with a luminescent layer,
which first portion, in operation, radiates light in a first range of the electromagnetic spectrum from 100 to 1000 nm,
a second portion of the discharge vessel being provided with a second electrode arranged in the discharge space,
which second portion, in operation, radiates light in a second range of the electromagnetic spectrum from 100 to 1000 nm, said second range being different from the first range, characterized in that:
the low-pressure mercury vapor discharge lamp comprises current supply conductors for receiving a direct current, and
the discharge space contains only two electrodes.

2. A low-pressure mercury vapor discharge lamp as claimed in claim 1, characterized in that an amalgam (4) is provided in the discharge vessel (1).

3. A low-pressure mercury vapor discharge lamp as claimed in claim 2, characterized in that the amalgam (4) is provided in the region between the first and the second portion (11, 21) of the discharge vessel (1).

4. A low-pressure mercury vapor discharge lamp as claimed in claim 2, characterized in that the amalgam is provided in the region of the electrode (12) of the portion (11) of the discharge vessel (1) with the lowest color temperature.

5. A low-pressure mercury vapor discharge lamp as claimed in claim 2 or 4, characterized in that the amalgam is provided in the region of the first electrode (12), and a further amalgam (24) is provided in the region of the second electrode (22).

6. A low-pressure mercury vapor discharge lamp as claimed in claim 1, 2, 3 or 4, characterized in that a cold spot is provided in the discharge vessel (1).

7. A low-pressure mercury vapor discharge lamp as claimed in claim 6, characterized in that the cold spot is provided in the region between the first and the second portion (11, 21) of the discharge vessel (1).

8. A low-pressure mercury vapor discharge lamp as claimed in claim 6 in combination with claim 2, 3 or 4 or as claimed in claim 7 in combination with claim 2, 3 or 4, characterized in that the amalgam is provided in the region of the cold spot.

9. A low-pressure mercury vapor discharge lamp as claimed in claim 1, 2, 3 or 4, characterized in that a wall of the second portion (21) of the discharge vessel (1) is made from a glass which is transmissive to UV.

10. A low-pressure mercury vapor discharge lamp as claimed in claim 1, 2, 3 or 4, characterized in that, in operation, the luminescent layer (16) yields a spectral characteristic stimulating melatonin built-up in a human subject or yields a spectral characteristic suppressing the melatonin built-up or stimulating melatonin degradation in the human subject.

11. A low-pressure mercury vapor discharge lamp as claimed in claim 1, 2, 3 or 4, characterized in that the second portion (21) of the discharge vessel (1) is provided with a further luminescent layer (26).

12. A low-pressure mercury vapor discharge lamp as claimed in claim 11, characterized in that, in operation, the further luminescent layer (26) yields a spectral characteristic suppressing the melatonin built-up in a human subject or stimulating melatonin degradation or yields a spectral characteristic stimulating melatonin built-up in the human subject.

13. A low-pressure mercury vapor discharge lamp as claimed in claim 10 and 12, characterized in that, in operation, the luminescent layer (16) yields a spectral characteristic stimulating melatonin built-up in the human subject and that the further luminescent layer (26) yields a spectral characteristic suppressing the melatonin built-up or stimulating melatonin degradation in the human subject.

14. A low-pressure mercury vapor discharge lamp as claimed in claim 10, 12 or 13, characterized in that the spectral characteristic is specified by an output fraction of melatonin suppressive radiation Rₛᵣ and light output Lₒ, the melatonin suppressive radiation being Rₛᵣ≧0.45 Melatonin Watt/Watt and the light output being Lₒ≦60 lumen/Watt.

15. A low-pressure mercury vapor discharge lamp as claimed in claim 10, 12 or 13, characterized in that the spectral characteristic is specified by an output fraction of melatonin suppressive radiation Rₛᵣ and light output Lₒ, the melatonin suppressive radiation being Rₛᵣ≧0.6 Melatonin Watt/Watt and the light output being Lₒ≧100 lumen/Watt, the discharge lamp having a color temperature of ≧6500 K.

16. A low-pressure mercury vapor discharge lamp as claimed in claim 10, 12 or 13, characterized in that the spectral characteristic is specified by an output fraction of melatonin suppressive radiation Rₛᵣ and light output Lₒ, the melatonin suppressive radiation being Rₛᵣ≦0.2 Melatonin Watt/Watt and the light output being Lₒ≧100 lumen/Watt.

17. A low-pressure mercury vapor discharge lamp as claimed in claim 11, characterized in that the luminescent layer (16) of the first portion (11) comprises a luminescent material emitting UV-A radiation, and in that the further luminescent layer (26) of the second portion (21) comprises a luminescent material emitting UV-B radiation or emitting UV-A and UV-B radiation.

18. A low-pressure mercury vapor discharge lamp as claimed in claim 1, 2, 3 or 4, characterized in that the low-pressure mercury vapor discharge lamp is adapted to receive an alternating current.

19. A low-pressure mercury vapor discharge lamp as claimed in claim 1, 2, 3 or 4 characterized in that
the discharge lamp comprises an at least partly substantially cylindrical discharge vessel (1) with a length L_{dv} and with an internal diameter Dᵢₙ, and
the ratio of the weight of mercury m_{Hg} in the discharge vessel (1) and the product of the internal diameter Dᵢₙ and the length of the discharge vessel L_{dv} is given by the relation:
$$\frac{{m}_{Hg}}{{D}_{in} \times {L}_{dv}} = C ,$$
wherein C≦0.01 μg/mm².

20. A low-pressure mercury vapor discharge lamp as claimed in claim 19, characterized in that 0.0005≦C≦0.005 μg/mm².

21. A low-pressure mercury vapor discharge lamp as claimed in claim 1, 2, 3 or 4 characterized in that
the discharge lamp comprises an at least partly substantially cylindrical discharge vessel (1) with a length L_{dv} and with an internal diameter Dᵢₙ, and
the product of the mercury pressure p_{Hg} and the internal diameter Dᵢₙ of the discharge vessel (1) is in the range 0.13≦p_{Hg}×Dᵢₙ≦8 Pa.cm.

22. A low-pressure mercury vapor discharge lamp as claimed in claim 21, characterized in that the product of the mercury pressure p_{Hg} and the internal diameter Dᵢₙ of the discharge vessel (1) is in the range 0.13≦p_{Hg}×Dᵢₙ≦4 Pa.cm.

23. A low-pressure mercury vapor discharge lamp as claimed in claim 1, 2, 3 or 4, characterized in that the discharge vessel (1) contains less than 0.2 mg mercury.

24. A compact fluorescent lamp comprising a low-pressure mercury-vapor discharge lamp as claimed in claim 1, 2, 3 or 4, characterized in that a lamp housing (70) is attached to the discharge vessel (1) of the low-pressure mercury-vapor discharge lamp, which lamp housing is provided with a lamp cap.

25. A compact fluorescent lamp as claimed in claim 24, characterized in that the discharge vessel (1) of the low-pressure mercury-vapor discharge lamp is surrounded by a diffusely scattering light-transmitting envelope which is attached to the lamp housing (70).
